(19) United States
(12) Patent Application Publication
(10) Pub. No.: US 2019/0257457 A1
(43) Pub. Date: Aug. 22, 2019

(54) Seed Cart Coupler System

(71) Applicants: Andrew H. Hoenhause, Lisbon, ND (US); Mitchell P. Hoenhause, Lisbon, ND (US)

(72) Inventors: Andrew H. Hoenhause, Lisbon, ND (US); Mitchell P. Hoenhause, Lisbon, ND (US)

(21) Appl. No.: 15/900,911

(22) Filed: Feb. 21, 2018

(51) Int. Cl. F16L 39/00; F16L 23/06

(52) U.S. Cl. CPC F16L 39/00; A01C 7/06; F16L 23/06

(57) ABSTRACT

A seed cart coupler system for providing efficient connection of air seeder hoses between a seed cart and air seeder with a corrosion resistant coupler. The seed cart coupler system generally includes a first connector adapted to be removably connected to a second connector. The first connector includes a plurality of tubes that fluidly connect to corresponding seed hoses of a seed cart and the second connector includes a plurality of tubes that fluidly connect to corresponding seed hoses of an air seeder. The first connector and the second connector fluidly connect the seed tubes of the seed cart and the air seeder when connected together. The first connector and the second connector are preferably constructed of a material that is not corroded by fertilizer.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a seed cart coupler system for providing efficient connection of air seeder hoses between a seed cart and air seeder with a corrosion resistant coupler.

### Related Art

Any discussion of the related art throughout the specification should in no way be considered as an admission that such related art is widely known or forms part of common general knowledge in the field.

Air seeders are agricultural implements pulled by a tractor to apply seed and/or fertilizer to a field. Air seeders typically have a seed cart (a.k.a. air cart) that is pulled behind the air seeder. The seed cart stores a volume of seed to be planted and fertilizer. Seed hoses connected to the seed cart transport the seed and fertilizer to the air seeder which distributes the seed and fertilizer to seeder units for planting in a field. The seed cart is detachable from the air seeder which requires disconnecting the seed hoses from the air seeder. U.S. Pat. No. 6,672,627 to Mariman discloses a Lightweight Air Coupler for use in removably connecting the seed hoses of the seed cart with the air seeder. One of the problems with conventional air couplers is they are constructed of materials that corrode (e.g. mild steel, aluminum).

### SUMMARY

An example embodiment is directed to a seed cart coupler system. The seed cart coupler system includes a first connector adapted to be removably connected to a second connector. The first connector includes a plurality of tubes that fluidly connect to corresponding seed hoses of a seed cart and the second connector includes a plurality of tubes that fluidly connect to corresponding seed hoses of an air seeder. The first connector and the second connector fluidly connect the seed tubes of the seed cart and the air seeder when connected together. The first connector and the second connector are preferably constructed of a material that is not corroded by fertilizer.

There has thus been outlined, rather broadly, some of the embodiments of the seed cart coupler system in order that the detailed description thereof may be better understood, and in order that the present contribution to the art may be better appreciated. There are additional embodiments of the seed cart coupler system that will be described hereinafter and that will form the subject matter of the claims appended hereto. In this respect, before explaining at least one embodiment of the seed cart coupler system in detail, it is to be understood that the seed cart coupler system is not limited in its application to the details of construction or to the arrangements of the components set forth in the following description or illustrated in the drawings. The seed cart coupler system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1a is a top view of a seed cart coupler system in accordance with an example embodiment.

FIG. 1b is a magnified top view of the seeder air cart connector in accordance with an example embodiment.

FIG. 2 is a top view of the seed cart coupler system in accordance with an example embodiment.

FIG. 3 is a side view of the seed cart coupler system in accordance with an example embodiment.

FIG. 4a is a cross sectional view taken along line 4a-4a of FIG. 3 with the first connector and the second connector removably attached to one another.

FIG. 4b is the cross sectional view of FIG. 4a with the first connector and the second connector separated.

FIG. 5 is a top view of the seed cart coupler system with the first connector and the second connector separated in accordance with an example embodiment.

FIG. 6 is an upper perspective view of the seed cart coupler system in accordance with an example embodiment.

FIG. 7 is side view of the second connector in accordance with an example embodiment.

FIG. 8 is a top view of the second connector in accordance with an example embodiment.

FIG. 9 is an end view of the second connector in accordance with an example embodiment.

FIG. 10 is side view of the first connector in accordance with an example embodiment.

FIG. 11 is a top view of the first connector in accordance with an example embodiment.

FIG. 12 is an end view of the first connector in accordance with an example embodiment.

FIG. 13 is a side view of an alternative embodiment of the second connector.

FIG. 14 is a top view of an alternative embodiment of the second connector.

FIG. 15 is a side view of an alternative embodiment of the first connector.

FIG. 16 is a top view of an alternative embodiment of the first connector.

### DETAILED DESCRIPTION

An example seed cart coupler system generally comprises a first connector 30 adapted to be removably connected to a second connector 50. The first connector 30 includes a plurality of tubes that fluidly connect to corresponding seed hoses of a seed cart 10 and the second connector 50 includes a plurality of tubes that fluidly connect to corresponding seed hoses of an air seeder 20. The first connector 30 and the second connector 50 fluidly connect the seed tubes of the seed cart 10 and the air seeder 20 when connected together. The first connector 30 and the second connector 50 are preferably constructed of a material that is not corroded by fertilizer. The various embodiments of the present invention may be used to removably connect a single hose, two hoses, three hoses, four hoses or more between the seed cart 10 and the air seeder 20.

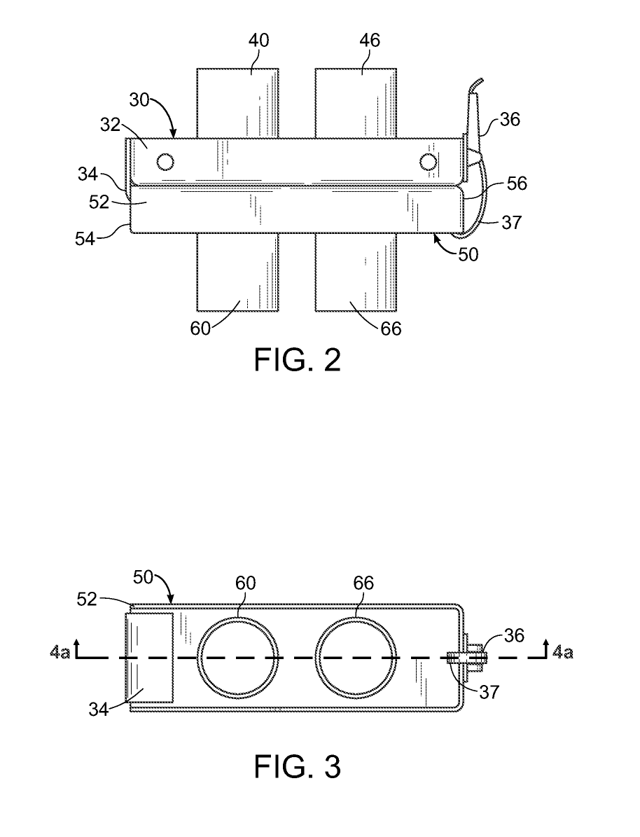

The first connector 30 includes a first frame 32, a first tube 40 extending outwardly from the first frame 32 and a second tube 46 extending outwardly from the first frame 32 as illustrated in FIGS. 2, 4a through 6. In an alternative embodiment, the first connector 30 includes a fifth tube 74 extending outwardly from the first frame 32 as illustrated in FIG. 14.

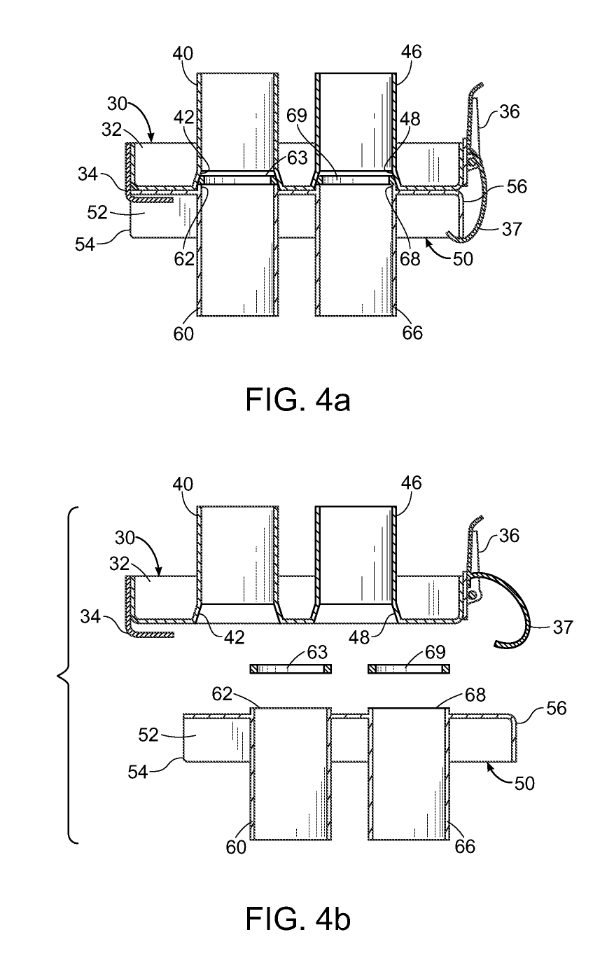

The first frame 32 is preferably rectangular shaped but may have various other shapes (e.g. oval, square, etc.). The first frame 32 may be comprised of a flat base portion and a perimeter lip that extends outwardly from the perimeter of the flat base portion as shown in FIGS. 4a through 6 of the drawings.

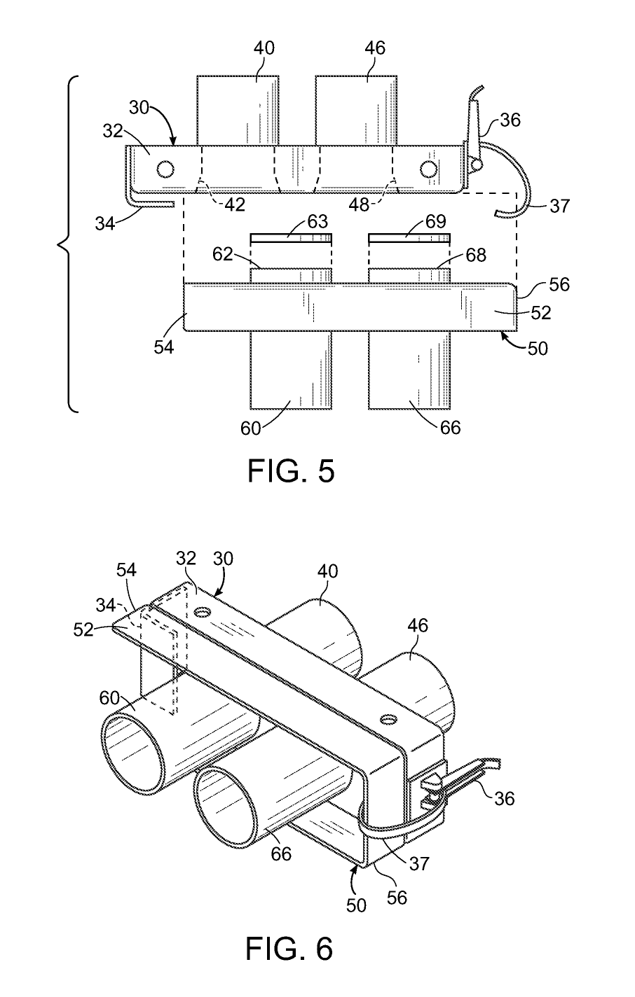

The first connector 30 includes a lip member 34 that is removably attachable to a first end 54 of the second connector 50 as illustrated in FIGS. 3 through 5 of the drawings. The lip member 34 has an L-shaped structure that creates a receiver slot that removably receives the first end 54 of the second connector 50 as best illustrated in FIGS. 4b and 5 of the drawings. The extended portion of the lip member 34 is preferably parallel with respect to a base portion of the first connector 30 as shown in FIG. 4b of the drawings. However, the extended portion of the lip member 34 may be angled outwardly. The inner portion of the lip member 34 is attached to an end of the first frame 32 and the extended portion extends transversely from the inner portion of the lip member 34 as further shown in FIG. 4b of the drawings.

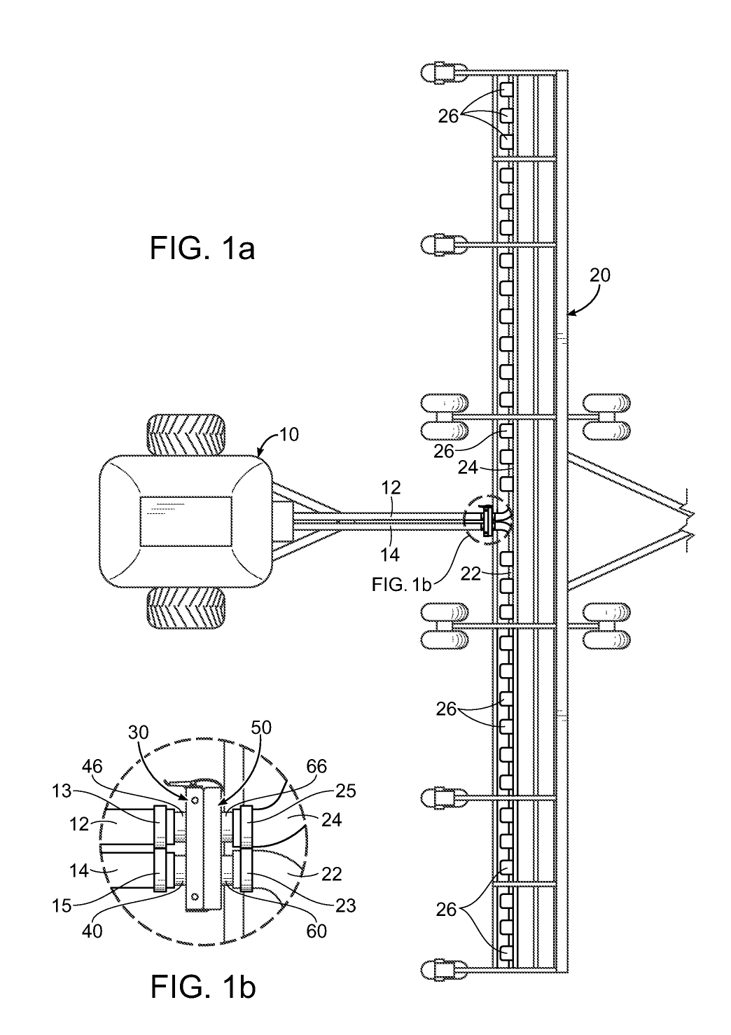

The first connector 30 also includes a clamping device attached to an end portion of the first connector 30 opposite of the lip or alternatively connected to the second end 56 of the second connector 50. The clamping device is used to secure the ends of the first connector 30 and second connector 50 together that are opposite of the lip member 34 as shown in FIG. 4a of the drawings. The clamping device may be released to allow for the first connector 30 and the second connector 50 to be separated as shown in FIGS. 4b and 5 of the drawings. When the clamping device is in a locked position (FIGS. 1b, 2, 4a and 6), then the first connector 30 is not separable from the second connector 50 thereby providing fluid connection between the hoses 12, 14, 22, 24 as discussed herein. The first connector 30 preferably includes a clamping end 37 that removably attaches to a second end 56 of the second connector 50 as illustrated in FIG. 4a of the drawings. The clamping end 37 is illustrated as having a hooked structure, however, various other structures capable of engaging the second end 56 of the second connector 50 may be used.

The second connector 50 is adapted to be removably connected to the first connector 30 as shown in FIGS. 2, 4a through 6 of the drawings. The second connector 50 includes a second frame 52, a third tube 60 extending outwardly from the second frame 52 and a fourth tube 66 extending outwardly from the second frame 52. In an alternative embodiment shown in FIG. 16, the second connector 50 includes a sixth tube 70 extending outwardly from the second frame 52.

The second frame 52 is preferably rectangular shaped but may have various other shapes (e.g. oval, square, etc.). The second frame 52 may be comprised of a flat base portion and a perimeter lip that extends outwardly from the perimeter of the flat base portion as shown in FIGS. 4a through 6 of the drawings.

The distal ends of the first tube 40, the second tube 46 and the fifth tube 74 are adapted to connect to a first hose 12, a second hose 14 and a third hose 22 of a seed cart 10 respectively. The distal ends of the third tube 60, the fourth tube 66 and sixth tube 70 are adapted to connect to a third hose 22, a fourth hose 24 and a fifth hose of an air seeder 20 respectively. Hose clamps 13, 15, 23, 25 may be used to secure the hoses to the tubes as illustrated in FIG. 1b of the drawings.

When the first connector 30 and the second connector 50 are connected together as shown in FIGS. 1b, 2, 4a and 6 of the drawings, the first tube 40 is fluidly connected to the third tube 60 and the second tube 46 is fluidly connected to the fourth tube 66 to allow for the transfer of seed and/or fertilizer between the respective hoses extending between the seed cart 10 and the air seeder 20. In the alternative embodiment shown in FIGS. 13 through 16, the fifth tube 74 is fluidly connected to the sixth tube 70 when the first connector 30 and the second connector 50 are connected together.

When the first connector 30 and the second connector 50 not connected together as shown in FIGS. 4b and 5, the first tube 40 is not fluidly connected to the third tube 60, the second tube 46 is not fluidly connected to the fourth tube 66 (and the fifth tube 74 is not fluidly connected to the sixth tube 70 in the alternative embodiment). When the first connector 30 and the second connector 50 are not connected together, the first connector 30 and the second connector 50 along with their respectively connected hoses may be completely separated thereby allowing separation of the seed cart 10 from the air seeder 20.

The first tube 40, the second tube 46 and the fifth tube 74 preferably extend in a direction away from the third tube 60, the fourth tube 66 and the sixth tube 70. The first tube 40, the second tube 46 and fifth tube 74 are also preferably parallel to one another. The third tube 60, the fourth tube 66 and sixth tube 70 are also preferably parallel to one another.

The first tube 40 is preferably concentric with the third tube 60, the second tube 46 is preferably concentric with the fourth tube 66 and the fifth tube 74 is preferably concentric with the sixth tube 70 when the first connector 30 is connected to the second connector 50. The first tube 40, the second tube 46, the third tube 60, the fourth tube 66, the fifth tube 74 and the sixth tube 70 each preferably have a circular cross sectional shape though different shapes may be used.

The first connector 30 preferably includes a first tapered inlet 42 extending into an interior side of the first connector 30 that is fluidly connected to the first tube 40. The first connector 30 also preferably includes a second tapered inlet 48 extending into the interior side of the first connector 30 that is fluidly connected to the second tube 46. The first connector 30 also preferably includes a third tapered inlet 76 extending into the interior side of the first connector 30 that is fluidly connected to the fifth tube 74 in the alternative embodiment shown in FIGS. 14 and 16 of the drawings.

The second connector 50 preferably includes a first connector tube 62 extending from an interior side of the second connector 50 that is fluidly connected to the third tube 60. The second connector 50 also preferably includes a second connector tube 68 extending from the interior side of the second connector 50 that is fluidly connected to the fourth tube 66. The second connector 50 also preferably includes a third connector tube 72 extending from the interior side of the second connector 50 that is fluidly connected to the fifth tube 74 in the alternative embodiment shown in FIGS. 14 and 16 of the drawings. The first connector tube 62, the second connector tube 68 and the third connector tube 72 are received within the first tapered inlet 42, the second tapered inlet 48 and the third tapered inlet 76 respectively in a substantially sealed manner when the first connector 30 is connected to the second connector 50.

It is preferable that a first seal 63 is connected to the distal end or near the distal end of the first connector 30 tube to seal with the corresponding first tapered inlet 42 when the first connector 30 and second connector 50 are connected together. It is preferable that a second seal 69 is connected to the distal end or near the distal end of the second connector 50 tube to seal with the corresponding second tapered inlet 48 when the first connector 30 and second connector 50 are connected together. It is further preferable that a third seal is connected to the distal end or near the distal end of the third connector tube to seal with the corresponding third tapered inlet 76 when the first connector 30 and second connector 50 are connected together in the alternative embodiment shown in FIGS. 13 through 16. The seals 63, 69 may be comprised of various types of seals (e.g. O-rings, lip seals, oil seals) and material types (e.g. rubber).

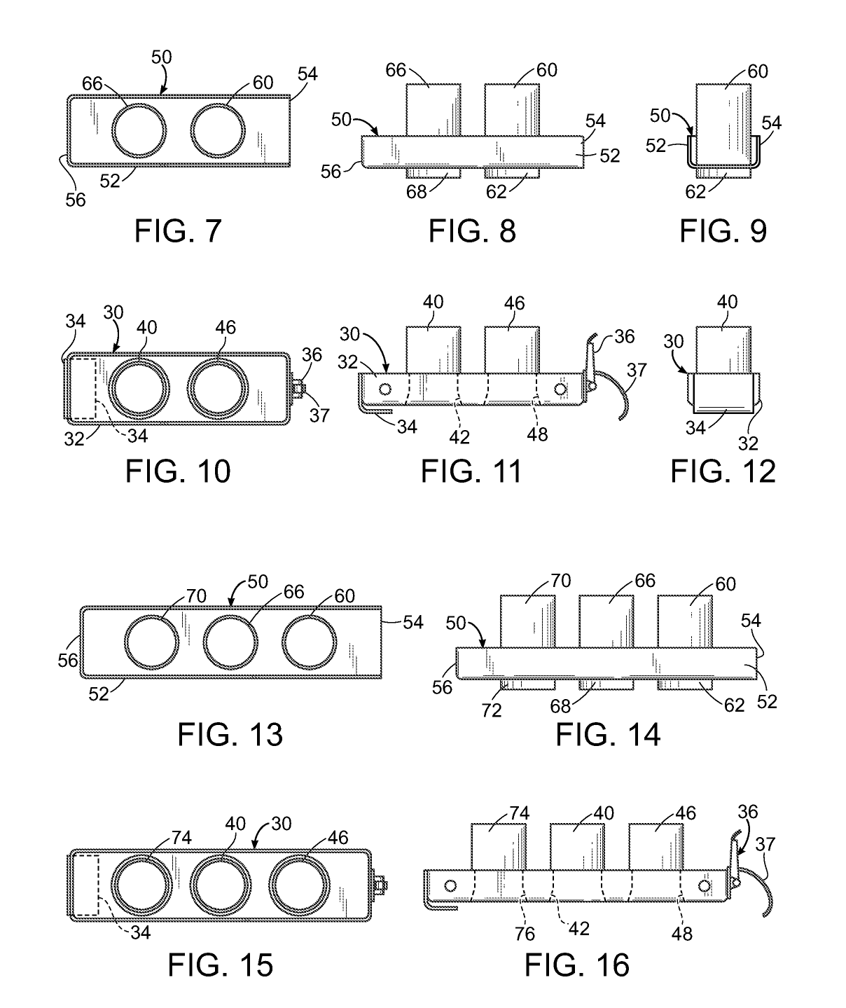

The first tube 40, the second tube 46 and the fifth tube 74 extend outwardly from an exterior side of the first connector 30, and the third tube 60, the fourth tube 66 and the sixth tube 70 extend outwardly from an exterior side of the second connector 50 as shown in FIGS. 1 through 16 of the drawings. When the first connector 30 is connected to the second connector 50, the respective interior sides of the first connector 30 and the second connector 50 are preferably adjacent and parallel to one another as shown in FIGS. 2 and 4a of the drawings.

The first connector 30 is preferably constructed of the same material. The first connector 30 is further preferably constructed of a corrosion resistant material that is resistant to corrosion by fertilizer commonly used in agriculture such as, but not limited to, stainless steel. While the various components of the first connector 30 may be constructed of different materials, it is preferable that a substantial portion of the components are constructed of the corrosion resistant material that is resistant to corrosion to fertilizer. It is further preferable that the entire first connector 30 is constructed of the corrosion resistant material to reduce down time in the field during seeding. Furthermore, it is preferable that the entire first connector 30 is constructed of stainless steel which is resistant to most forms of fertilizer used in agriculture. In particular, it is preferable that the first frame 32, the lip member 34, the clamp device 36, the first tube 40, the second tube 46 and the fifth tube 74 are all constructed of stainless steel in one of the preferred embodiments of the invention.

The second connector 50 is preferably constructed of the same material. The second connector 50 is further preferably constructed of a corrosion resistant material that is resistant to corrosion by fertilizer commonly used in agriculture such as, but not limited to, stainless steel. While the various components of the second connector 50 may be constructed of different materials, it is preferable that a substantial portion of the components are constructed of the corrosion resistant material that is resistant to corrosion to fertilizer. It is further preferable that the entire second connector 50 is constructed of the corrosion resistant material to reduce down time in the field during seeding. Furthermore, it is preferable that the entire second connector 50 is constructed of stainless steel which is resistant to most forms of fertilizer used in agriculture. In particular, it is preferable that the second frame 52, the third tube 60, the fourth tube 66 and the sixth tube 70 are all constructed of stainless steel in one of the preferred embodiments of the invention.

In use, the user connects the hoses 13, 15, 23, 25 to the respective tubes 40, 46, 60, 66 of the connectors 30, 50 as shown in FIGS. 1a and 1b. When the seed cart 10 is connected to the air seeder 20, the user then connects the first connector 30 to the second connector 50 in a sealed manner so that the first hose 12 is fluidly connected to the third hose 22 in a substantially sealed manner and the second hose 14 is fluidly connected to the fourth hose 24 in a substantially sealed manner to reduce the amount of air pressure drop and to prevent interference of the air flow with seed and fertilizer passing through the hoses and the connectors 30, 40. To connect the first connector 30 to the second connector 50, the user inserts the first end 54 of the second connector 50 into the receiver slot of the first connector 30 defined by the lip member 34 and then positions the first connector 30 and second connector 50 substantially parallel to one another. The user then connects the clamping device and manually positions and leverages the clamping end 37 to connect to a lip portion of the second frame 52 thereby drawing the first connector 30 and the second connector 50 together as shown in FIGS. 2, 4a and 6 of the drawings. Once the first connector 30 is fully connected to the second connector 50, the user may operate the air seeder 20 as they normally would. When the user wants to separate the seed cart 10 from the air seeder 20, the user simply releases the clamp device 36 and separates the first connector 30 and the second connector 50 as shown in FIG. 4b of the drawings.

Unless otherwise defined, all technical and scientific terms used herein have the same meaning as commonly understood by one of ordinary skill in the art to which this invention belongs. Although methods and materials similar to or equivalent to those described herein can be used in the practice or testing of the seed cart coupler system, suitable methods and materials are described above. All publications, patent applications, patents, and other references mentioned herein are incorporated by reference in their entirety to the extent allowed by applicable law and regulations. The seed cart coupler system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A seeder air cart coupler, comprising:
a first connector including a first frame, a first tube extending outwardly from the first frame and a second tube extending outwardly from the first frame, wherein distal ends of the first tube and the second tube are adapted to connect to a first hose and a second hose of a seed cart respectively; and
a second connector adapted to be removably connected to the first connector, wherein the second connector includes a second frame, a third tube extending outwardly from the second frame and a fourth tube extending outwardly from the second frame, wherein the distal ends of the third tube and the fourth tube are adapted to connect to a third hose and a fourth hose of an air seeder respectively;
wherein when the first connector and the second connector are connected together, the first tube is fluidly connected to the third tube and the second tube is fluidly connected to the fourth tube;
wherein when the first connector and the second connector not connected together, the first tube is not fluidly connected to the third tube and the second tube is not fluidly connected to the fourth tube;
wherein the first connector and the second connector are comprised of a corrosion resistant material that is resistant to corrosion by fertilizer.

2. The seeder air cart coupler of claim 1, wherein the material is comprised of stainless steel.

3. The seeder air cart coupler of claim 2, wherein the entire first connector and the entire second connector are comprised of stainless steel.

4. The seeder air cart coupler of claim 1, wherein the first tube and the second tube extend in a direction away from the third tube and the fourth tube.

5. The seeder air cart coupler of claim 1, wherein the first tube and the second tube are parallel to one another, and wherein the third tube and the fourth tube are parallel to one another.

6. The seeder air cart coupler of claim 1, wherein the first tube is concentric with the third tube and the second tube is concentric with the fourth tube when the first connector is connected to the second connector.

7. The seeder air cart coupler of claim 1, wherein the first tube, the second tube, the third tube and the fourth tube each have a circular cross sectional shape.

8. The seeder air cart coupler of claim 1, wherein the first connector includes a first tapered inlet extending into an interior side of the first connector that is fluidly connected to the first tube, wherein the first connector includes a second tapered inlet extending into the interior side of the first connector that is fluidly connected to the second tube, wherein the second connector includes a first connector tube extending from an interior side of the second connector that is fluidly connected to the third tube, wherein the second connector includes a second connector tube extending from the interior side of the second connector that is fluidly connected to the fourth tube, wherein the first connector tube and the second connector tube are received within the first tapered inlet and the second tapered inlet respectively when the first connector is connected to the second connector.

9. The seeder air cart coupler of claim 8, wherein the first tube and the second tube extend outwardly from an exterior side of the first connector, wherein the third tube and the fourth tube extend outwardly from an exterior side of the second connector, and wherein when the first connector is connected to the second connector, the respective interior sides of the first connector and the second connector are adjacent and parallel to one another.

10. The seeder air cart coupler of claim 8, wherein the first connector includes a lip member that is removably attachable to the first end of the second connector; and wherein the first connector further includes a clamping device having a clamping end that removably attaches to a second end of the second connector.

11. A seeder air cart coupler, comprising:
a first connector including a first frame, a first tube extending outwardly from the first frame and a second tube extending outwardly from the first frame; and
a second connector adapted to be removably connected to the first connector, wherein the second connector includes a second frame, a third tube extending outwardly from the second frame and a fourth tube extending outwardly from the second frame;
wherein the first connector includes a fifth tube extending outwardly from the first frame and wherein the second connector includes a sixth tube extending outwardly from the second frame;
wherein distal ends of the first tube, the second tube and the fifth tube are adapted to connect to a first hose, a second hose and a third hose of a seed cart respectively;
wherein the distal ends of the third tube, the fourth tube and sixth tube are adapted to connect to a third hose, a fourth hose and a fifth hose of an air seeder respectively;
wherein when the first connector and the second connector are connected together, the first tube is fluidly connected to the third tube, the second tube is fluidly connected to the fourth tube and the fifth tube is fluidly connected to the sixth tube;
wherein when the first connector and the second connector not connected together, the first tube is not fluidly connected to the third tube, the second tube is not fluidly connected to the fourth tube and the fifth tube is not fluidly connected to the sixth tube;
wherein the first connector and the second connector are comprised of a corrosion resistant material that is resistant to corrosion by fertilizer.

12. The seeder air cart coupler of claim 11, wherein the material is comprised of stainless steel.

13. The seeder air cart coupler of claim 12, wherein the entire first connector and the entire second connector are comprised of stainless steel.

14. The seeder air cart coupler of claim 11, wherein the first tube, the second tube and the fifth tube extend in a direction away from the third tube, the fourth tube and the sixth tube.

15. The seeder air cart coupler of claim 11, wherein the first tube, the second tube and fifth tube are parallel to one another, and wherein the third tube, the fourth tube and sixth tube are parallel to one another.

16. The seeder air cart coupler of claim 11, wherein the first tube is concentric with the third tube, the second tube is concentric with the fourth tube and the fifth tube is concentric with the sixth tube when the first connector is connected to the second connector.

17. The seeder air cart coupler of claim 11, wherein the first tube, the second tube, the third tube, the fourth tube, the fifth tube and the sixth tube each have a circular cross sectional shape.

18. The seeder air cart coupler of claim 11, wherein the first connector includes a first tapered inlet extending into an interior side of the first connector that is fluidly connected to the first tube, wherein the first connector includes a second tapered inlet extending into the interior side of the first connector that is fluidly connected to the second tube, wherein the first connector includes a third tapered inlet extending into the interior side of the first connector that is fluidly connected to the fifth tube, wherein the second connector includes a first connector tube extending from an interior side of the second connector that is fluidly connected to the third tube, wherein the second connector includes a second connector tube extending from the interior side of the second connector that is fluidly connected to the fourth tube, wherein the second connector includes a third connector tube extending from the interior side of the second connector that is fluidly connected to the fifth tube, wherein the first connector tube, the second connector tube and the third connector tube are received within the first tapered inlet, the second tapered inlet and the third tapered inlet respectively when the first connector is connected to the second connector.

19. The seeder air cart coupler of claim 18, wherein the first tube, the second tube and the fifth tube extend outwardly from an exterior side of the first connector, wherein the third tube, the fourth tube and the sixth tube extend outwardly from an exterior side of the second connector, and wherein when the first connector is connected to the second connector, the respective interior sides of the first connector and the second connector are adjacent and parallel to one another.

20. A seeder air cart coupler, comprising:
a first connector including a first frame, a first tube extending outwardly from the first frame and a second tube extending outwardly from the first frame; and
a second connector adapted to be removably connected to the first connector, wherein the second connector includes a second frame, a third tube extending outwardly from the second frame and a fourth tube extending outwardly from the second frame;
wherein the first connector includes a fifth tube extending outwardly from the first frame and wherein the second connector includes a sixth tube extending outwardly from the second frame;
wherein distal ends of the first tube, the second tube and the fifth tube are adapted to connect to a first hose, a second hose and a third hose of a seed cart respectively;
wherein the distal ends of the third tube, the fourth tube and sixth tube are adapted to connect to a third hose, a fourth hose and a fifth hose of an air seeder respectively;
wherein when the first connector and the second connector are connected together, the first tube is fluidly connected to the third tube, the second tube is fluidly connected to the fourth tube and the fifth tube is fluidly connected to the sixth tube;
wherein when the first connector and the second connector not connected together, the first tube is not fluidly connected to the third tube, the second tube is not fluidly connected to the fourth tube and the fifth tube is not fluidly connected to the sixth tube;
wherein the first connector and the second connector are comprised of a corrosion resistant material that is resistant to corrosion by fertilizer, wherein the material is comprised of stainless steel, and wherein the entire first connector and the entire second connector are comprised of stainless steel;
wherein the first tube, the second tube and the fifth tube extend in a direction away from the third tube, the fourth tube and the sixth tube;
wherein the first tube, the second tube and fifth tube are parallel to one another, and wherein the third tube, the fourth tube and sixth tube are parallel to one another;
wherein the first tube is concentric with the third tube, the second tube is concentric with the fourth tube and the fifth tube is concentric with the sixth tube when the first connector is connected to the second connector;
wherein the first tube, the second tube, the third tube, the fourth tube, the fifth tube and the sixth tube each have a circular cross sectional shape;
wherein the first connector includes a first tapered inlet extending into an interior side of the first connector that is fluidly connected to the first tube, wherein the first connector includes a second tapered inlet extending into the interior side of the first connector that is fluidly connected to the second tube, wherein the first connector includes a third tapered inlet extending into the interior side of the first connector that is fluidly connected to the fifth tube, wherein the second connector includes a first connector tube extending from an interior side of the second connector that is fluidly connected to the third tube, wherein the second connector includes a second connector tube extending from the interior side of the second connector that is fluidly connected to the fourth tube, wherein the second connector includes a third connector tube extending from the interior side of the second connector that is fluidly connected to the fifth tube, wherein the first connector tube, the second connector tube and the third connector tube are received within the first tapered inlet, the second tapered inlet and the third tapered inlet respectively when the first connector is connected to the second connector;
wherein the first tube, the second tube and the fifth tube extend outwardly from an exterior side of the first connector, wherein the third tube, the fourth tube and the sixth tube extend outwardly from an exterior side of the second connector, and wherein when the first connector is connected to the second connector, the respective interior sides of the first connector and the second connector are adjacent and parallel to one another;
wherein the first connector includes a lip member that is removably attachable to the first end of the second connector; and wherein the first connector further includes a clamping device having a clamping end that removably attaches to a second end of the second connector.
